(19) United States
(12) Patent Application Publication
(10) Pub. No.: US 2021/0050578 A1
(43) Pub. Date: Feb. 18, 2021

(54) ENERGY STORAGE MODULE WITH ENERGY STORAGE CELLS AND/OR A COOLING SYSTEM CONNECTED BY UNINSULATED CONDUCTOR ELEMENTS, ENERGY STORAGE BLOCK AND METHOD FOR COOLING AN ENERGY STORAGE MODULE

(71) Applicant: STOBA E-SYSTEMS GMBH, Weinstadt (DE)

(72) Inventor: Achim FEDYNA, Westhausen (DE)

(21) Appl. No.: 16/965,502

(22) PCT Filed: Jan. 29, 2019
(86) PCT No.: PCT/EP2019/052124

§ 371 Date: Jul. 28, 2020

(30) Foreign Application Priority Data
Jan. 31, 2018 (DE) 10 2018 102 142.9

(51) Int. Cl. H01M 2/20; H01M 10/613; H01M 10/6563; H01M 10/625

(52) U.S. Cl. CPC H01M 2/206; H01M 10/613; H01M 2220/20; H01M 10/625; H01M 10/6563

(57) ABSTRACT

The invention relates to an energy storage module (1) for a vehicle drive system for supplying energy to an electric motor in a vehicle on the one hand or for supplying energy to an aggregate on the other hand, wherein a plurality of individual energy storage cells (2) are combined into a battery (3), wherein at least several of the energy storage cells (2) are electrically conductively connected to a plurality of connection boards (4), wherein the connection boards (4) are prepared for contacting at least one electronics board (5), wherein an electrical connection of an energy storage cell (2) to at least one of the connection boards (4) is implemented via at least one uninsulated conductor element (6) and/or cooling fluid directing means are present which guide fluid used for cooling and heat dissipation in a targeted manner in longitudinal direction of the energy storage cells (2) past the energy storage cells (2), wherein a heat transfer from the energy storage cells (2) to the fluid is however ensured. The invention also relates to a method for cooling such an energy storage module (1), wherein cooling fluid directing means are used which guide fluid in a targeted manner in longitudinal direction of the energy storage cells (2) past the energy storage cells (2) in order to implement cooling and heat dissipation, wherein a heat transfer from the energy storage cells (2) to the fluid is however ensured.

The invention relates to a device for integrating energy storage cells for forming a battery and electronic components in an energy storage module, a device for combining a plurality of energy storage cells into an energy storage block, as well as a device and a method for cooling the batteries.

In particular, the invention relates to an energy storage module for a vehicle drive system for supplying energy to an electric motor in a vehicle, for example also usable as a generator, on the one hand, such as a landborne, waterborne or airborne vehicle, for example a passenger car, a truck, a train, a ship or an aircraft, or for supplying energy to an aggregate, such as a pump or a generator, on the other hand, wherein a plurality of individual energy storage cells are combined/integrated into a battery, for example as a package, wherein at least several of the energy storage cells, preferably all energy storage cells, are electrically conductively connected to a plurality of connection boards, wherein the connection boards are prepared/configured for contacting at least one electronic board, possibly with an integrated battery management system (BMS).

Energy storage modules are already known from the state of the art. For example, the document DE 11 2014 004 708 T5 discloses an energy storage module in which a plurality of rectangular energy storage devices each having an electrode assembly and an electrolyte, wherein the energy storage devices are housed in a housing and configured so as to be connected to each other, wherein the plurality of energy storage devices are arrayed in a predetermined direction of alignment and are bonded to each other in an arrayed state, and wherein thicknesses of surfaces on bonded sides of the housing are smaller than thicknesses of surfaces on non-bonded sides.

The usage of batteries, as has been done so far, is not optimally solved in many applications, such as the electromobility and the technical field of energy supply, e.g. in domestic engineering. Until now, plugs and cables must be used. The plugs and cables are weight-intensive and cost-intensive, as they must meet certain safety requirements. Also, their usage is not space efficient. Particularly, this is shown when a battery management system (BMS) is used. A battery management system (BMS) is an electronic circuit which serves to monitor and control an arrangement of rechargeable energy storage cells and provides the necessary energy storage cell balancing. In order to ensure safe operation of the batteries, such a battery management system (BMS) is required, wherein each voltage level is usually monitored for series-connected cells. This is shown especially in the case of batteries with higher voltage levels, that the current serial wiring involves a considerable effort.

Furthermore, document DE 20 2010 017 685 U1, for example, discloses a connecting element for connecting cells of an electrical energy storage module, wherein the connecting element has a first contact portion, a second contact portion and a middle portion, wherein the two contact portions and the middle portion comprise electrically conductive metal and wherein the middle portion is arranged between the first contact portion and the second contact portion and mechanically and electrically connects the two contact portions to each other. For this purpose, a melting zone is formed in the middle portion which interrupts the electrical connection between the two contact portions in the case of melting, namely when an electrical current flowing through the connecting element exceeds a predetermined rated current significantly.

Also the document DE 11 2015 004 307 T5 discloses an energy storage module having a pair of end plates for clamping a plurality of secondary cells arranged in parallel in one direction, a first and a second cover part fixed to one end plate of the pair of end plates, wherein the first and second cover parts are arranged facing the upper surface of a casing, wherein an electrode connection is provided on the upper surface.

Furthermore, document WO 2007/033651 A1 discloses an energy storage package comprising a plurality of energy storage cells and at least two carrier units, the energy storage cells being arranged between the carrier units.

The object of the invention is to provide an energy storage module that meets the requirements of high-voltage batteries and that at the same time is simple to connect and offers a compact processing. When used in connection with the drive of a vehicle, the aim is to provide a weight-minimized and space-efficient structural unit that is at the same time universally applicable.

The object of the invention is achieved by a generic device according to the invention by implementing an electrical connection of an energy storage cell with the connection boards via at least one, preferably completely, uninsulated conductor element. Insulation can be dispensed with and through skillful choice of the connection location “small cross-section” connectors (i.e. connectors with small cross-section) can be used. Thus, the weight-intensive use of insulated cables can be dispensed with and the relatively expensive use of plugs and plug sockets can be omitted.

By means of the connection boards used in the energy storage module, which are advantageously arranged above and below the energy storage cells, it is on the one hand possible to electrically connect a plurality of storage cells with each other. On the other hand, it is also possible to combine the energy storage cells in a compact manner into a battery, such as a package. This has the advantage that the battery is a small energy storage module which can be installed in a vehicle or the like without much effort.

Advantageous embodiments are claimed in the subclaims and explained in more detail below.

For example, it is advantageous when the conductor element is configured as a wire or ribbon and/or that the conductor element has resilient or resetting properties. By using a conductor element configured as a wire or ribbon, the considerable effort of wiring the energy storage cell poles to each other by means of wires can be saved. By taking advantage of the resilient or resetting properties of the conductor element on both sides of the respective energy storage cell, the contact is not lost due to the inertial forces in the case of an external impact, since the recoil following the impact is also spring-loaded and the energy storage cell is returned to its original initial position after each movement. When the conductor element is configured as a wire or ribbon, there is no room for movement between the energy storage cell and the connection boards. An impact from the outside on the energy storage module does not lead to losing contact here either, since the impact-related dislocation of the energy storage cell ends in its initial position.

Furthermore, it is advantageous when the conductor element extends from a side facing the energy storage cell through or past the connection board to a side of the connection board facing away from the energy storage cell or the conductor element extends away from the energy storage cell only to the side of the connection board facing the energy storage cell.

Therefore, in other words, the one end of the conductor element is always fixed to one end of each energy storage cell and the other end of the conductor element is fixed either to the surface of the connection board respectively facing away from the energy storage cells or to the surface of the connection board respectively facing the energy storage cells. In this way, various embodiments are possible which each result in a compact energy storage module and facilitate a proper electrical contacting, are optimized for different application purposes. In both cases, it is advantageous that the conductor elements do not have to be crossed, which would otherwise entail more space and a necessary insulation of the conductor elements.

In particular, when both connection boards have through openings central to each energy storage cell in the respective connection board, for example in the form of holes, in particular boreholes, in order to guide the conductor element through, a simple and space-saving processing of the energy storage cells into an energy storage module can be achieved.

A further advantage arises when the length of the conductor element by such processing is smaller than the diameter of the energy storage cell, e.g. smaller than 1/20 of the diameter of the energy storage cell. This makes it possible to save space as well as manage with a lower total weight of the energy storage module. Also, the short length and small diameter of each conductor element is amongst others made possible by using conductive paths on the connection boards.

It is preferred when the conductor element is fixed to the energy storage cell by means of spot- and laser-welding process or ultrasonic bonding and when the conductor element is fixed to the connection board by means of soldering or bonding. In this way, the cost to establish an electrical connection between the respective energy storage cell poles is kept within limits and the usage of need-oriented connection methods for contacting is enabled.

Furthermore, it is advantageous when the conductor element(s) is/are configured in such a way and/or is/are predominantly horizontally aligned and/or run(s) on one side of the energy storage cells, since especially in this case no (unnecessarily) long conductor elements have to be used.

It is advantageous when the conductor element is configured as a spring which is used to fix the energy storage cells in the energy storage module, each spring being aligned so that it springs in the direction of the longitudinal axis of the energy storage cell. Such a configuration provides the energy storage cells with some freedom of movement to compensate for impacts from the outside.

It is preferred when the spring is attached either to the connection board and/or also to the energy storage cell itself. In this case, only one spring is used for each energy storage cell pole which is arranged centrally to the energy storage cell. This allows the distances to be kept the same, which facilitates assembly and simplifies installation. Interference between the connections is also avoided. Alternatively, per energy storage cell pole two conductor elements can be used for contacting. When only one conductor element is used, the current flowing through the cells, which must overcome the contact resistance between the energy storage cell pole and the connection board, causes an additional voltage drop and thus distorts the voltage measurement in the case of contacting with only one conductor element. By using two contacts at each energy storage cell pole, the energy storage cell voltage can be measured to the greatest possible extent currentless directly at the energy storage cell in accordance with the four wire-measurement principle.

The advantage of such a configuration is that a downstream battery management system can measure both energy storage cell voltage signals and compare the two signals with each other, thus enabling the implementation of an open circuit detection. In a conventional system, twice the number of wires would have to be installed for such functionality. In the present invention, only twice the number of conductor elements is required, thus resulting in negligible additional costs in comparison with the conventional system.

An advantage of contacting by means of a spring as a conductor element is when a single connection board is electrically conductively connected on its two sides with energy storage cells, in particular the one side with energy storage cells of a first energy storage module and the second side with energy storage cells of a second energy storage module. Therefore, (unnecessary) connecting material for the individual energy storage cells is dispensed with, as well as such conductor elements which must be guided through the connection boards and are therefore arranged on two different surfaces of the connection board.

Furthermore, it is advantageous when the energy storage cells of the energy storage module in the battery are serially connected to each other. The connection boards then offer the possibility to achieve a serial circuitry of the energy storage cells using the conductor paths used on the connection boards via short conductor elements.

In addition, it is advantageous when the energy storage cells are arranged in a chessboard-like pattern or in the manner of a dense package in order to save installation space.

In addition, the energy storage module has advantages when the electronic components with a battery management system (BMS) are arranged on the electronic board which is attached to a distal end of the battery. By this placement, the battery management system can be attached to the connection boards in combination with the electronic components in one piece. It should be noted that a plurality of electronic boards can also be combined into a common electronic board.

It is preferred when the electronic board is connected to the connection boards with a plug connection in order to obtain a more compact system and to allow an unproblematic contacting and electrical connection between the battery management system and the electronic components installed on the electronic board. In this way, the energy storage module comprises individual boards which are brought into contact with each other without any further wiring and a replacement of certain components is also made easier. As an alternative to plugging the electronic board directly onto the connection board, such a connection can be achieved via multicore cable connections, such as flat ribbon cables.

It is advantageous when certain electronic components are swapped out from the electronic board to the connection boards and that temperature sensors are inserted directly into the battery, whereby on the one hand space on the electronic board for electronic components that cannot be swapped out is created, and on the other hand a certain sorting of the electronic components is made possible. In other words, it is possible to place the temperature sensors directly into the battery. It is therefore advantageous when such electronic components which must meet power electronics requirements and are not swapped out are installed on the electronic board. Power electronics is understood as a branch of electrical engineering which deals with the conversion of electrical energy with switching electronic components.

It is advantageous to configure the plug connection in such a way that both the battery management system signals are guided to the connection boards and the power supply of the battery is provided via the plug connection. Especially due to the requirements, the plug connection are high-current connectors. High-current connectors are components through which electrical current can pass for the exclusive purpose of supplying power to a device. Thus, no data stream is conducted through these connectors. The advantage of the high-current connectors is that wires can be dispensed with.

A further embodiment is realized when cooling fluid conducting means are present which conduct fluid used for cooling and heat dissipation, such as air, in a targeted manner in the longitudinal direction of the energy storage cells past the energy storage cells, whereby a heat transfer from the energy storage cells to the fluid is however ensured. This helps prevent the individual energy storage cells from overheating and thus all energy storage cells have the same temperature.

Therefore, it is appropriate when the energy storage module and/or the energy storage modules are arranged in a common/unified housing to ensure uniform cooling of the energy storage cells and when the cooling fluid cannot escape.

It is preferable when the energy storage module and/or the energy storage modules are aligned horizontally so as to allow good cooling of the battery by forced air cooling and/or when the connection boards are slotted at proper locations or provided with through openings, such as boreholes, cut-outs or holes so that an air flow passing through the battery causes a forced cooling. In other words, the connection boards must be provided/displaced at proper locations with holes or cut-outs, so that air can flow through. In round cells the empty spaces between the individual energy storage cells are advantageous.

It is advantageous when an insulator is flatly slotted between two connection boards at proper locations or is provided with through openings, e.g. in the form of boreholes, cut-outs or holes, in order to direct the air flow in a targeted manner. These through openings should be adapted to the through openings of the connection boards. Here the insulator can be but does not have to be installed.

It is advantageous that an air baffle plate is respectively mounted above and below the energy storage module and/or the energy storage modules as flow guiding portion. These installed air baffle plates ensure that when a plurality of energy storage modules are placed one above the other, fresh air is available to each energy storage module. This helps prevent the upper energy storage module from being heated by the energy storage module underneath. The air baffle plates are also constituent parts of the housing.

It is advantageous when the air baffle plates are attached slantedly at a predetermined acute angle with respect to the horizontal to guide the cooling fluid accordingly. Thus, the lower air baffle plate has an angle greater than that of the upper air baffle plate. This results in an energy-efficient cooling fluid conducting, which on the one hand leads to a uniform temperature in the energy storage module and on the other hand allows an economical allocation of resources.

Furthermore, on the side facing the electronic board, a fan module is mounted, which is provided between the lower air baffle plate and the lowest energy storage module and contains one or more (small) fans. This fan module supports the first exhaust air flow/air flow which cools the energy storage cells.

It is advantageous when the housing and the flow guiding portion are configured so that the energy storage cells are cooled by a first exhaust air flow/air flow and the electronic components mounted on the electronic board and the battery management system are cooled by a second exhaust air flow/air flow, for example so that the first exhaust air flow/air flow is combined with the second exhaust air flow/air flow at the housing outlet. In this way, the two constituent parts of the energy storage module are cooled independently of each other.

The invention also relates to an energy storage block in which a plurality of energy storage modules according to one of the preceding aspects are combined. The advantage of such an energy storage block is that when a plurality of batteries are required, a plurality of energy storage modules are stacked atop of each other. It has the advantage that (exactly) two connection boards per energy storage module are available.

Advantageously, the energy storage block is configured so that one connection board is arranged opposite to one face side of the energy storage cells of an energy storage module and the other connection board is arranged opposite to the other face side of the energy storage cells of the energy storage module.

It is advantageous that the energy storage block is configured so that an insulator or a connection board is mounted between two adjacent energy storage modules, which connects both the lower and the upper energy storage module to each other. The insulator can be provided, but an insulator may also be dispensed with. By mounting a connection board between the respective energy storage modules, both the lower and the upper energy storage cells are connected to each other. The electronic board can still be connected to the side of the battery.

The invention also relates to a method for cooling at least one energy storage module, wherein a cooling fluid conducting means is used for conducting a cooling fluid, for example fluid, such as air, which is conducted in a targeted manner in the longitudinal direction of the energy storage cells past the energy storage cells in order to implement cooling and heat dissipation, wherein a heat transfer from the energy storage cells to the fluid is however ensured.

The invention is explained below by means of a drawing.

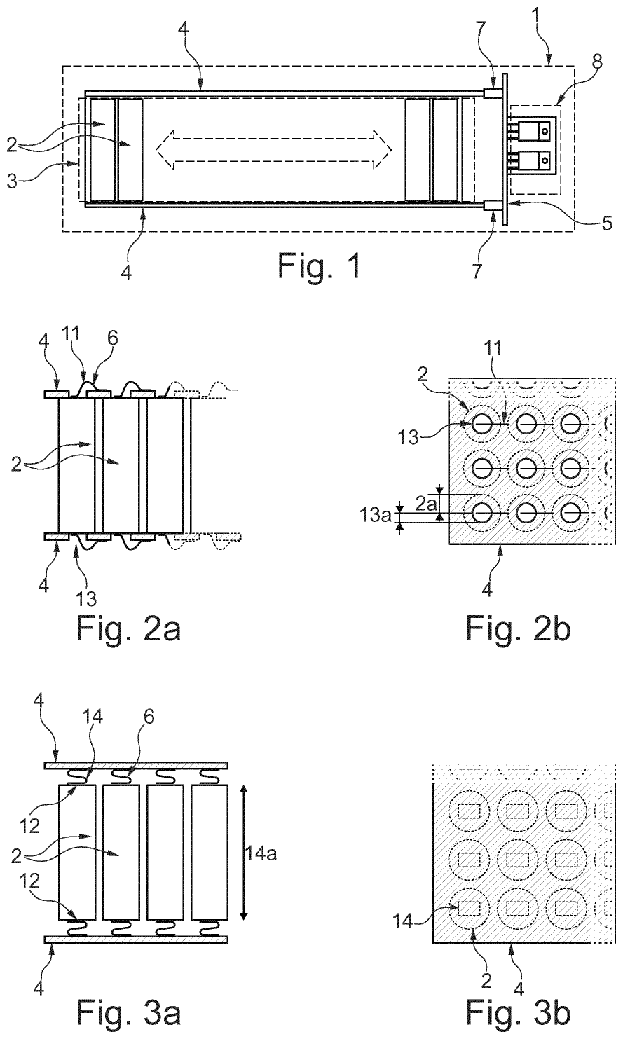

FIG. 1 shows a schematic structure of an energy storage module,

FIG. 2a shows a schematic side view of a contacting of the energy storage cells by means of ribbon or wire,

FIG. 2b shows a schematic top view of a contacting of the energy storage cells by means of ribbon or wire,

FIG. 3a shows a schematic side view of a contacting of the energy storage cells by means of springs,

FIG. 3b shows a schematic top view of a contacting of the energy storage cells by means of springs,

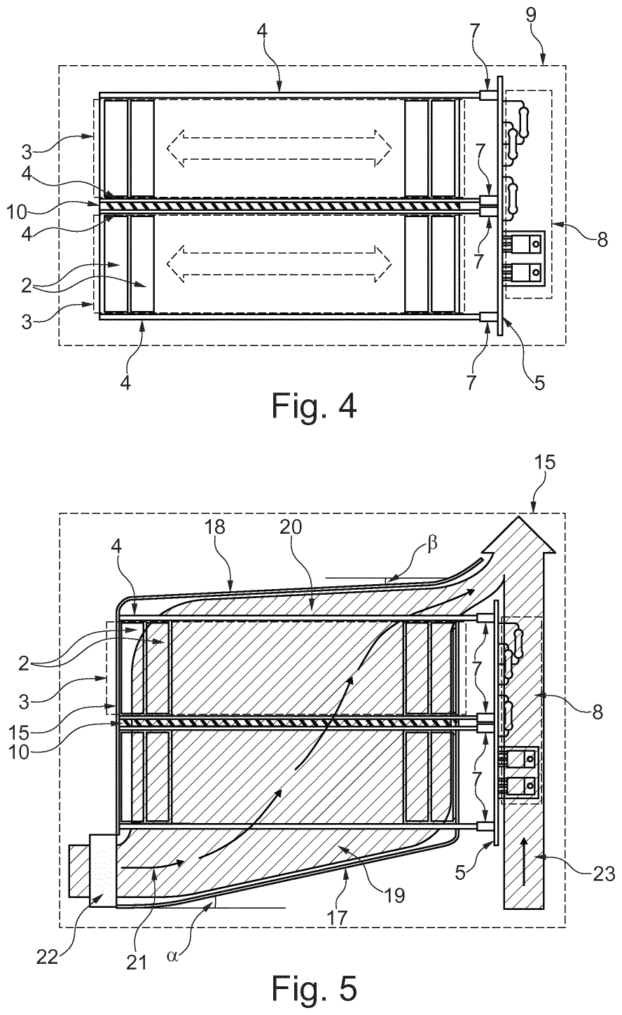

FIG. 4 shows a schematic structure of two energy storage cells in an energy storage block and

FIG. 5 shows a schematic structure of a cooling system of an energy storage block.

The figures are merely schematic in nature and exclusively used to understand the invention. The same elements are designated by the same reference signs.

FIG. 1 shows a schematic structure of an energy storage module 1. The energy storage module 1 comprises a plurality of energy storage cells 2, which are arranged adjacent to each other and grouped/combined into a battery 3. Energy storage cells 2 are arranged between two connection boards 4, wherein one connection board 4 is placed above the energy storage cells 2 and one connection board 4 is placed below the energy storage cells 2.

An electronic board 5 which is aligned perpendicularly to the connection boards 4 is arranged at the distal end of the battery 3 for contacting the connection boards 4. The individual energy storage cells 2 are electrically connected to the connection boards 4 via at least one uninsulated conductor element 6. The connection boards 4 are plugged onto the electronic board 5 by means of plug connections 7. Electronic components 8 as well as the battery management system and possibly required power electronic are arranged on the electronic board 5.

FIG. 2a shows a schematic side view of a contacting of the energy storage cells 2 by means of a ribbon or wire 11. The energy storage cells 2 are arranged according to FIG. 1 and electrically connected at their energy storage cell poles 12 with the connection boards 4 via a ribbon or wire 11. The ribbon or wire 11 contacts at an energy storage cell pole 12 with one end, passes through a through opening 13 in the connection board 4 and contacts on the side of the connection board 4 facing away from the energy storage cell 2 with the other end.

FIG. 2b shows a schematic top view of a contacting of the energy storage cells 2 by means of ribbon or wire 11 according to FIG. 2a. The arrangement of the energy storage cells 2 between the connection boards 4 shows a chessboard-like pattern. The ribbon or wire 11 always points in the same direction and can be shorter than the radius 2a of the energy storage cells 2 and the radius 13a of the through openings 13 is smaller than the radius 2a of the energy storage cells 2. The through openings 13 are arranged centrally to the energy storage cells 2.

FIG. 3a shows a schematic side view of a contacting of the energy storage cells 2 by means of springs 14. The energy storage cells 2 are arranged according to FIG. 1 and electrically connected at their energy storage cell poles 12 with the connection boards 4 via a spring 14. The spring 14 is at one end in contact with an energy storage cell pole 12 and at the other end in contact with the side of the connection board 4 facing the energy storage cell 2. The springs 14 enable a springing of the energy storage cells 2 in spring direction 14a. The contacts of the energy storage cells 2 thus only take place on one side of the respective connection board 4.

FIG. 3b shows a schematic plan view of a contacting of the energy storage cells 2 by means of springs 14 according to FIG. 3a. The arrangement of the energy storage cells 2 between the connection boards 4 shows a chessboard-like pattern. The springs 14 are arranged centrally to the energy storage cells 2 corresponding to the ribbon or wire 11.

FIG. 4 shows a schematic structure of two energy storage modules 2 according to FIG. 1 in an energy storage block 9. The two energy storage modules 1, whereby more than two energy storage modules 1 can also be used, are arranged one above the other and the electronic board 5 extends with the electronic components 8 attached thereto perpendicularly to the connection boards 4 over the complete side of the batteries 3 arranged one above the other, in the present case at their distal ends. Each connection board 4 is plugged onto the electronic board 5 by means of plug connections 7. An insulator 10 can be inserted between the two connection boards 4 in contact with each other, i.e. between the upper connection board 4 of a lower energy storage module and the lower connection board 4 of an upper energy storage module, but it can also be omitted.

FIG. 5 shows a schematic structure of a cooling system 15 of an energy storage block 9. The energy storage block 9, which can comprise two or more batteries 3 according to the embodiment of FIG. 4, is enclosed in a housing 16, wherein the housing 16 comprises a first air baffle plate 17 at the lower end and a second air baffle plate 18 at the upper end and the electronic board 5 as well as the plug connections 7 between the connection boards 4 are located outside the housing.

The first air baffle plate 17 defines the first flow guiding portion 19 and the second air baffle plate 18 defines the second flow guiding portion 20. The angle α of the first air baffle plate 16 with respect to the horizontal is greater than the angle β of the second air baffle plate 18 with respect to the horizontal. The first flow guiding portion 19 guides the first exhaust air flow/air flow 21 through the batteries 3 and passes into the second flow guiding portion 20. The first exhaust air flow/air flow 21 is guided by a fan module 22, which is mounted between the first air baffle plate 17 and the lower battery 3 at the distal end of the battery 3 opposite to the electronic board 5 and can alternatively comprise one or more fans. The first exhaust airflow/airflow 21 uses the existing interspaces of the energy storage cells 2 and the corresponding through openings and slots (not shown) in the connection boards 4 as well as in the insulator 10 to cool the individual energy storage cells 2 equally.

The second exhaust air flow/air flow 23 serves to cool the electronic components 8 on the electronic board 5 and guides from the lower end to the upper end of the electronic board 5. The first and second exhaust air flow 21, 23 are brought together and discharged after cooling the corresponding portions/elements and components.

### LIST OF REFERENCE SIGNS

1 energy storage module
2 energy storage cell
2a radius of the energy storage cell
3 battery
4 connection board
5 electronic board
6 conductor element
7 plug connection
8 electronic components
9 energy storage block
10 isolator
11 wire and/or ribbon
12 energy storage cell pole
13 through opening
13a radius of through opening
14 springs
14a spring direction
15 cooling system
16 housing
17 first air baffle plate
18 second air baffle plate
19 first flow guiding portion
20 second flow guiding portion
21 first exhaust air flow
22 Fan module
23 second exhaust air flow

1. Energy storage module for a vehicle drive system for supplying energy to an electric motor for a vehicle on the one hand or for supplying energy to an aggregate on the other hand, wherein a plurality of individual energy storage cells are combined into a battery, wherein at least several of the energy storage cells are electrically conductively connected with a plurality of connection boards, wherein the connection boards are prepared for contacting at least one electronic board, wherein an electrical connection of an energy storage cell with at least one of the connection boards is implemented via at least one uninsulated conductor element and the conductor element is configured as a wire or ribbon and the at least one electronic board is arranged at a distal end of the battery.

2. Energy storage module according to claim 1, wherein the conductor element has resilient or resetting properties.

3. Energy storage module according to claim 1, wherein the conductor element extends from a side facing the energy storage cell through the connection board or past the connection board to a side of the connection board facing away from the energy storage cell or the conductor element extends away from the energy storage cell only to the side of the connection board facing the energy storage cell.

4. Energy storage module according to claim 1, wherein the electronic board is arranged at a distal end of the battery.

5. Energy storage module according to claim 1, wherein the electronic components with a battery management system are arranged on the electronic board.

6. Energy storage module for a vehicle drive system for supplying energy to an electric motor in a vehicle on the one hand, or for supplying energy to an aggregate on the other hand, wherein a plurality of individual energy storage cells are combined into a battery, wherein at least several of the energy storage cells are electrically conductively connected to a plurality of connection boards, wherein the connection boards are prepared for contacting at least one electronic board according to one of the preceding claims, wherein cooling fluid conducting means are available, which guide fluid used for cooling and for heat dissipation in a targeted manner in a longitudinal direction of the energy storage cells past the energy storage cells, wherein a heat transfer from the energy storage cells to the fluid is however ensured.

7. Energy storage module according to claim 6, wherein the energy storage modules are arranged in a common housing.

8. Energy storage module according to claim 6, wherein the energy storage modules are configured so that the connection boards are slotted at proper locations or provided with through openings so that an air flow guided through the battery causes forced cooling.

9. Energy storage block, in which a plurality of energy storage modules according to claim 1 are used.

10. Method for cooling an energy storage module according to claim 1, wherein cooling fluid conducting means are used, which guides fluid in a targeted manner in a longitudinal direction of the energy storage cells past the energy storage cells in order to implement cooling and heat dissipation, wherein a heat transfer from the energy storage cells to the fluid is however ensured.

11. Energy storage block, in which a plurality of energy storage modules according to claim 6 are used.
